(19) United States
(12) Patent Application Publication
(10) Pub. No.: US 2008/0298287 A1
(43) Pub. Date: Dec. 4, 2008

(54) PRIORITY SCHEME FOR COMMUNICATION SYSTEM

(75) Inventors: Ricardo Martinez-Perez, Plantation, FL (US); Roberto Gautier, Davie, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/755,240

(22) Filed: May 30, 2007

(51) Int. Cl. G08C 17/00

(52) U.S. Cl. 370/311

(57) ABSTRACT

A priority scheme method (300) for a communication system (100) at a base station (110) is described herein. The method can include the steps of receiving (310) from one or more mobile devices (120, 130) a power status message and allocating (315) a data profile of a frame based on the power status messages to enable higher priority mobile devices to receive data in the frame before lower priority mobile devices. As an example, the power status message may indicate whether a mobile device is being powered by a portable power source (175) or a non-portable power source (195).

### BACKGROUND OF THE INVENTION

1. Field of the Invention

The claimed subject matter concerns priority schemes for communication systems and more particularly, priority schemes based on power status.

2. Description of the Related Art

There is a general move in the wireless industry towards broadband communications. In particular, several companies are developing communication equipment based on the Institute of Electrical and Electronics Engineers (IEEE) standard 802.16e, more commonly referred to as Worldwide Interoperability for Microwave Access (WiMAX). In this standard, mobile devices typically monitor downlink (DL) channels for data. Specifically, a mobile device will monitor a DL subframe until the burst of data assigned to the mobile device has been received by the mobile device. At that point, the mobile device will shut down its receiver until it powers the receiver back up for the next frame in the channel.

Although WiMAX does provide support for sleep and idle modes to enable power-saving operation by the mobile devices, it does not provide a mechanism to efficiently allocate elements within a DL map. That is, there is no guideline in place for the base station to follow when the base station allocates the data bursts in the DL subframe. As such, mobile devices are required to keep their receivers on for a relatively lengthy period of time while waiting to receive their data in the DL subframe. This process may negatively affect battery life performance.

### SUMMARY OF THE INVENTION

A priority scheme method for a communication system is disclosed. The method can include the steps of—at a base station—receiving from one or more mobile devices a power status message and allocating a data profile of a frame based on the power status messages. This process can enable higher priority mobile devices to receive data in the frame before lower priority mobile devices. In one embodiment, the power status messages can be discreet messages transmitted over an uplink channel or are part of a pre-existing message transmitted over the uplink channel. Allocating the data profile of a frame based on the power status messages may include scheduling in a DL map or a UL map data transmissions such that the data transmissions for the higher priority mobile devices are allocated before the data transmissions for the lower priority mobile devices.

As an example, the power status message can indicate whether a mobile device is being powered by a portable power source or a non-portable power source. If the power status message indicates that the mobile device is being powered by a portable power source, the power status message can also indicate the amount of charge remaining on the portable power source. As another example, a mobile device being powered by a portable power source can be a higher priority mobile device, and a mobile device being powered by a non-portable power source can be a lower priority mobile device. In another arrangement, the data transmissions for a mobile device with a portable power source with a first amount of charge can be scheduled before the data transmissions for a mobile device with a portable power source with a second amount of charge in which the first amount of charge is lower than the second amount of charge.

The method can also include the step of allocating periods of absence based on the power status messages in which longer periods of absences are allocated to the higher priority mobile devices over the lower priority mobile devices. In addition, larger data bursts can be allocated based on the power status messages in which the larger data bursts are allocated to the higher priority mobile devices. The method may also include the step of dynamically cycling the allocation of data profiles based on the power status messages for subsequent frames.

Another priority scheme method for a broadband communication system is disclosed. The method can include the steps of—at a base station—receiving a power status message from one or more mobile devices in which the power status messages are associated with the type of power sources that are currently providing power to the mobile devices and based on the power status messages, scheduling data transmissions for the mobile devices in a DL map such that the transmissions intended for mobile devices providing power status messages that indicate a power critical status are allocated prior to the transmission intended for mobile devices providing power status messages that indicate a power non-critical status. A “power critical status” can be defined as an indication that a mobile device is receiving its power from a portable power source, as that term is defined below. A “power non-critical status” can be defined as an indication that a mobile device is receiving its power from a non-portable power source, as that term is defined below.

This method can further include the step of—based on the power status messages—scheduling data transmissions for the mobile devices in a UL map such that the transmissions from mobile devices providing power status messages that indicate a power critical status are allocated prior to the transmissions from mobile devices providing power status messages that indicate a power non-critical status. As an example, the power critical status refers to the mobile device being currently powered by a battery and the power non-critical status refers to a mobile device being powered by a hard-wired power system.

A base station is also described herein. The base station can include a transceiver that receives power status messages from one or more mobile devices in which some of the mobile devices are powered by a portable power source and some of the mobile devices are powered by a non-portable power source. The base station can also include a scheduler coupled to the transceiver. In one arrangement, the scheduler can schedule data transmissions based on the power status messages. In particular, the scheduler may grant in a transmission map a higher priority to the data transmissions that are associated with the mobile devices powered by the portable power sources. As an example, the transmission map can be a DL map or a UL map, and the base station can be part of a communication system that uses orthogonal frequency-division multiplexing (OFDM) modulation. The base station can include suitable software and circuitry to perform any of the method steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a communication system;

FIG. 2 illustrates an example of a DL subframe; and

FIG. 3 illustrates an example of a priority scheme method for a communication system.

### DETAILED DESCRIPTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the claimed subject matter are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claimed subject matter in virtually any appropriately detailed structure. Further, the terms and phrases used herein are not intended to be limiting but rather to provide an understandable description.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “mobile device” can be any portable component or group of portable components that are capable of receiving and/or transmitting communications signals. A “base station” can be any infrastructure component that is capable of exchanging wireless signals with a mobile station. A “transceiver” can be any component or group of components that are capable of receiving or transmitting wireless signals over a suitable medium. The term “data” can mean any type of information that can be transmitted over a wireless medium. A “scheduler” can include any component or group of components that are capable of allocating data profiles in accordance with the description herein using any suitable form of hardware, software or combination thereof.

A “data profile” can refer to any suitable allocation of data transmissions, whether UL or DL transmissions. A “data burst” can be defined as any block of data that is intended for transmission to or from a particular mobile device. A “downlink map” can be defined as any guide that informs a mobile device about resource allocation in downlink communications. Similarly, an “uplink map” can be defined as any guide that informs a mobile device about resource allocation in uplink communications. Both of these terms may also be synonymous with a transmission map. The term “period of absence” can mean any amount of time in which the transmitter or receiver of a mobile device is permitted to be shut down.

A priority scheme method and system for a communication system is described herein. The method can include the steps of—at a base station—receiving from one or more mobile devices a power status message and allocating a data profile of a frame based on the power status messages to enable higher priority mobile devices to receive data in the frame before lower priority mobile devices. Allocating the data profile of a frame based on the power status messages may include scheduling in a DL map or a UL map data transmissions such that the data transmissions for the higher priority mobile devices are allocated before the data transmissions for the lower priority mobile devices.

As an example, the power status message can indicate whether a mobile device is being powered by a portable power source or a non-portable power source. If the power status message indicates that the mobile device is being powered by a portable power source, the power status message can also indicate the amount of charge remaining on the portable power source. As such, the base station can ensure that mobile devices powered with portable power sources, particularly those with little charge left on them, can receive their data transmissions before mobile devices that have non-portable power sources. By doing so, the mobile devices with portable power sources can shut down their receivers first for each frame, which can help improve battery life for these devices.

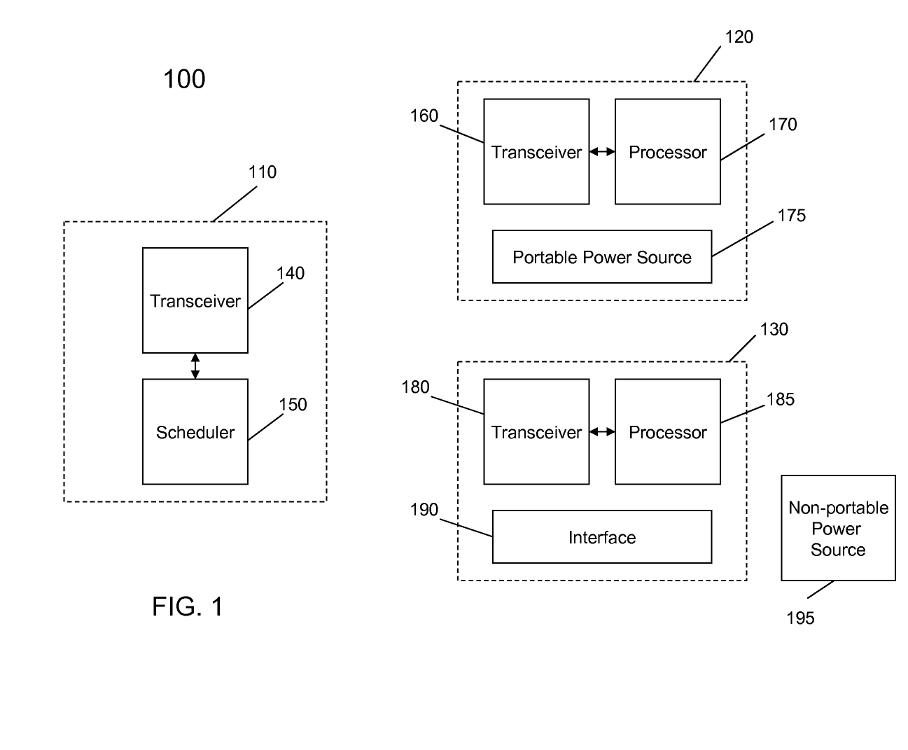

Referring to FIG. 1, a communication system 100 is shown in which a base station 110 is in wireless communications with a mobile device 120 and another mobile device 130. The base station 110 can be part of any suitable communications network that can facilitate communications between the mobile stations 120, 130 and the communication network. As an example, the base station 110 and the mobile stations 120, 130 can communicate with one another over a communication link that may support multiple transmission modes, as the transmissions between the base station 110 and the mobile stations 120, 130 can be simultaneously multi-dimensional in space, time and frequency domains. For example, the communication system 100 can use orthogonal frequency-division multiplexing (OFDM) modulation during operation. As a more specific example, the communication system 100 can employ IEEE standard 802.16e or 802.16m as a protocol to carry out communications. It is understood, however, that the system 100 is not limited in any way to these examples, as other suitable modulation schemes and protocols may be utilized.

In one arrangement, the base station 110 can include a transceiver 140 and a scheduler 150. In addition, the mobile device 120 can include a transceiver 160 and a processor 170 coupled to the transceiver 160. The mobile device 120 can also include a portable power source 175 that provides power to the transceiver 160, the processor 170 and any other suitable elements of the mobile device 120. A portable power source can mean any power source that generates electrical power independent of an electrical power grid and that is exhaustible and will deplete over time until the source reaches a level where it no longer is able to provide sufficient power. As an example, the portable power source 175 can be a rechargeable battery.

The mobile device 130 can also include a transceiver 180 and a processor 185 coupled to the transceiver 180. In one arrangement, the mobile device 130 can have an interface 190 that can receive power from a non-portable power source 195. A non-portable power source can be any power source that is part of or is connected to an electrical power grid and that it is not intended to be carried along with the electrical device to which it supplies power. As an example, the non-portable power source 195 can be a docking station, a charger or some other component coupled to an AC-powered wall outlet.

In one arrangement, the mobile devices 120, 130 can signal the base station 110 with the type of power source (i.e., portable or non-portable) used to power the devices 120, 130. In response, the base station 110 can arrange data bursts that are assigned to the mobile devices 120, 130 in such a way as to ensure that the mobile device 120, which is being powered by the portable power source 175, receives or transmits its data in a frame before the mobile device 130, which is being powered by the non-portable power source 195. This process will be described further below.

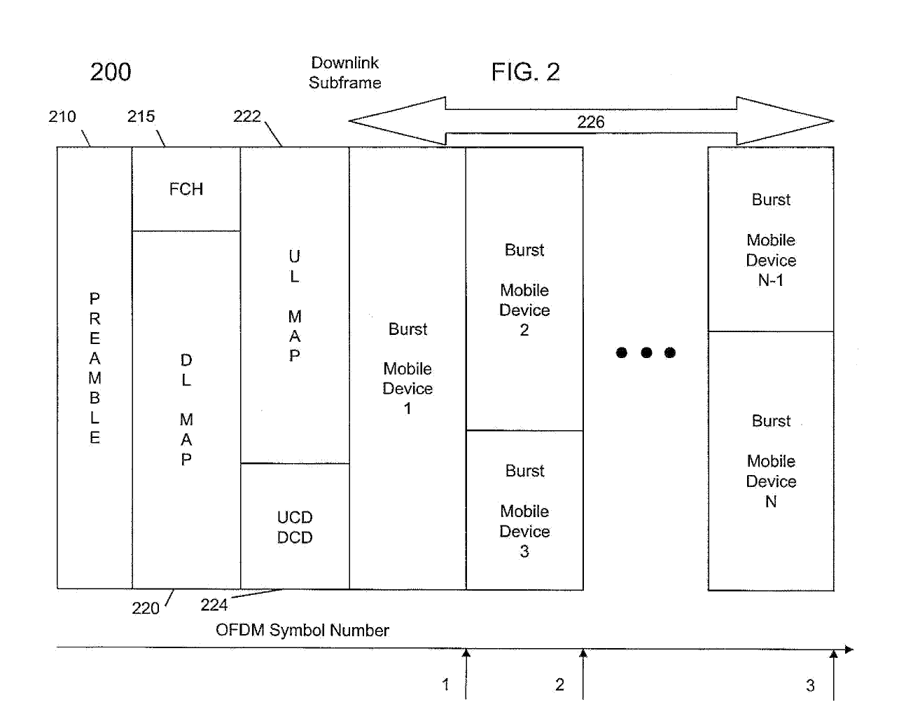

Referring to FIG. 2, an example of a DL subframe 200 is shown, although it is important to note that the claimed subject matter is not limited to this arrangement. The DL subframe 200 can be part of an OFDM frame, as is known in the art. The DL subframe 200 can include a preamble 210, a frame control header (FCH) 215, a DL map 220, a UL map 222, an uplink channel descriptor (UCD) and a downlink channel descriptor (DCD) 224 and a payload portion 226. The payload portion 226 shows an example of a data burst profile or a data profile, which will be explained later. As is known in the art, the DL map 220 and the UL map 222 can contain burst allocations for each OFDM frame, which can be set by the base station 110. The mobile devices 120, 130 can process the DL map 220 and the UL map 222 to determine where their burst allocations are in the current frame.

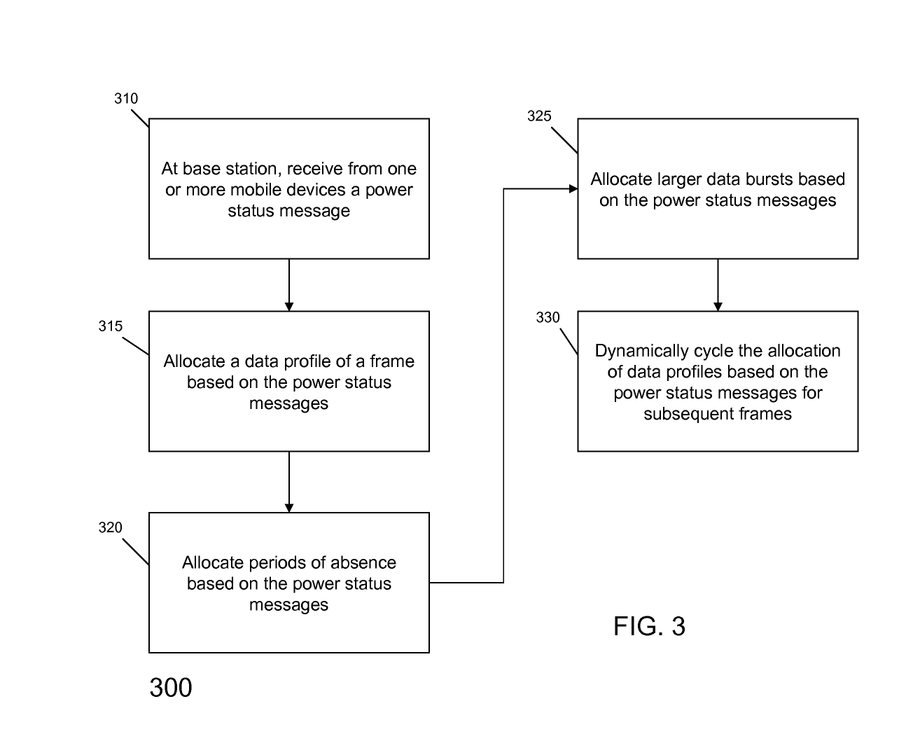

Referring to FIG. 3, a priority scheme method 300 for a communication system is shown. To describe this method 300, reference will be made to FIGS. 1 and 2, although it must be understood that the method 300 can be practiced in any other suitable system or component using any other suitable modulation scheme or protocol. The steps of the method 300 are not limited to the particular order in which they are presented in the figures. Moreover, any of these methods can have a greater number of steps or a fewer number of steps than those shown in the figures.

At step 310, the base station 110 can receive from one or more of the mobile devices 120, 130 a power status message. A power status message can be defined as any suitable indicator that a base station can process to determine how a mobile device is receiving its power and, optionally, an amount of remaining charge on the unit providing power to the mobile device, if applicable. The mobile devices 120, 130 can transmit the power status messages to the base station 110 at any suitable time, including in accordance with a uniform periodic rate or when a status change makes it necessary to send an updated power status message.

As an example, the mobile device 120 may receive its power from the portable power source 175, which can be a battery, and the mobile device 130 can receive its power from the non-portable power source 195, which can be a charger. The mobile devices 120, 130 can signal the base station 110 with their respective power configurations. In one arrangement, the power status message can be a discrete message the mobile devices 120, 130 can transmit over an uplink channel to the base station 110. In another arrangement, the power status message can be part of a pre-existing message that the mobile devices 120, 130 can transmit over the uplink channel. For example, the power status message can be generated by stealing padding bits from a pre-existing message that is part of the communications protocol employed by the base station 110 and the mobile devices 120, 130. Those of skill in the art will appreciate, however, that there are numerous other ways for a relevant mobile device to signal a relevant base station with power status messages.

At step 315, a data profile of a frame can be allocated based on the power status messages, which can enable higher priority mobile devices to receive data in the frame before lower priority mobile devices. For example, once it receives the power status messages, the base station 110 can prioritize data transmissions intended for the mobile devices 120, 130 based on these received messages. For example, referring to FIG. 2, the scheduler 150 of the base station 110 can schedule data transmissions in the DL map 220 and/or the UL map 222 such that data transmissions for higher priority mobile devices are allocated before those for lower priority mobile devices.

In particular, in this example, the mobile device 120, which is powered by the portable power source 175, can be considered as Mobile Device 1. The mobile device 130, which is powered by the non-portable power source 195, can be considered as Mobile Device 2. In this data profile, the mobile device 120 can shut down its transceiver 160 once its data burst (Burst-Mobile Device 1) is complete, which is designated by the arrow labeled with the number 1. At a later time, the mobile device 130 can shut down its transceiver 180 once its burst (Burst-Mobile Device 2) is over, which is designated by the arrow labeled with the number 2. Here, the mobile device 120 can be the higher priority mobile device—while the mobile device 130 can be the lower priority device—because the mobile device 120 is powered by a portable power source. Eventually, both transceivers 160, 180 can be powered back up at the start of the next frame, and the process described above can be repeated.

Of course, there may be more than two mobile devices in the communication system 100. The scheduler 150 may allocate data transmissions in the DL subframe 200 such that all the higher priority devices, those powered with portable power sources, receive their data prior to the lower priority devices, those powered with non-portable power sources. In addition, the scheduler 150 can prioritize these transmissions based on other factors. For example, the power status message, as noted earlier, may include information about how much charge is left on a portable power source 175. The scheduler 150 can prioritize the transmissions such that a mobile device with less charge on its portable power source 175 can receive its data before a mobile device with a greater amount of charge on its source 175. That way, the mobile device with the lower amount of charge on its portable power source 175 can shut down its transceiver 160 first to conserve energy.

Other factors in prioritizing data transmissions may be considered. Specifically, the type of portable power source 175 or non-portable power source 195 may factor into the decisions. For example, a mobile device 120 that has a portable power source 175 that is susceptible to a relatively quick power drain may be prioritized before other devices having portable sources 175. As another example, a mobile device 130 that has a relatively unstable non-portable power source 195, such as one that is susceptible to blackouts, may be prioritized over other devices having more stable non-portable power sources 195.

There may be instances where a mobile device switches its power supply. For example, the mobile device 130 may be receiving its power from a non-portable power source 195, such as a charger. When the mobile device 130 is removed from the charger, the mobile device 130 may begin to be powered from a portable power source 175, if such a unit is available. In response, the processor 185 can generate an updated power status message that indicates that the mobile device 130 is now being powered by a portable power source 175. The base station 110 can then give a higher priority to the data transmissions for the mobile device 130, as described above. This priority can be lowered if the mobile device 130 is powered again by the non-portable power source 195.

The above description has been provided in reference to a DL map. It is important to note, however, that this prioritization process can apply to a UL map, as well. In particular, if it is part of its routine, the scheduler 150 may prioritize uplink transmissions from the mobile devices 120, 130 such that transmissions from the mobile device 120 can be scheduled to occur before those from the mobile device 130. This process can allow the transceiver 160 to shut down for the rest of the frame before the transceiver 180, which conserves energy where it is needed most.

The base station 110 can take advantage of the information gleaned from the power status messages in other useful ways. For example, referring back to FIG. 3, at step 320, periods of absence can be allocated based on the power status messages. In one arrangement, longer periods of absence can be allocated to the higher priority mobile devices over the lower priority mobile devices. Also, larger data bursts can be allocated based on the power status messages, as shown at step 325. The larger data bursts can be allocated to the higher priority mobile devices. At step 330, the allocation of data profiles can be dynamically cycled based on the power status messages for subsequent frames.

Referring to FIGS. 1 and 2 again, the base station 110, as is known in the art, can assign mobile devices to a particular paging group. A paging group can define how often a mobile device must wake up to determine if a base station needs to transmit data to the mobile device. Paging groups have varying sleep intervals, which can serve as an example of a period of absence. As such, certain paging groups have longer sleeping intervals, or the amount of time the transceiver of a mobile device may be shut down until it is required to wake up for signal detection, as compared to other groups. In view of the power status messages, the base station 110 can assign higher priority mobile devices, such as device 120, to a paging group with a longer sleep interval. In contrast, the lower priority mobile devices, such as device 130, can be assigned to a paging group with a shorter sleep interval. Because it is powered with the non-portable power source 195, the mobile device 130 is better suited for the greater number of wake-ups over a given period of time.

In another arrangement, the scheduler 150 of the base station can assign larger data bursts to the mobile devices being powered with portable power sources 175. For example, the data burst labeled as “Burst Mobile Device 1” can contain more data in comparison to the data burst labeled as “Burst Mobile Device 3.” In this example, Mobile Device 1 can be a mobile device powered with a portable power source 175, while Mobile Device 3 can be a mobile device powered by a non-portable power source 195. Here, Mobile Device 1 can possibly receive its entire data burst allocation in one frame or in fewer frames than might be necessary because the bursts contain more data than normal. The larger data bursts can come at the expense of the allocations of Mobile Device 3, which may have to process a greater number of bursts over a greater number of frames to receive its data. The performance of Mobile Device 3, however, is not severely affected in view of its power configuration.

In view of the allocation of the data profiles described above, a scenario exists where a high priority mobile device would always be placed in front of other high priority mobile devices, given that other factors are essentially equivalent. For example, consider three mobile devices 120 being powered with portable power sources 175 with roughly equal amounts of charge or where the amount of charge is not taken into account during the allocation process. One of the three mobile devices may consistently receive its data prior to the others for each successive frame. To prevent this occurrence, the scheduler 150 can dynamically cycle the allocation of data profiles. For example, one of the mobile devices can have its data allocated first for a particular frame, while another mobile device can have its data allocated first in a successive frame. This process can be repeated to ensure that the mobile devices have their allocation positions repeatedly changed to ensure a more equitable distribution. If desired, this process may also be applied to mobile devices that are powered by non-portable power sources 195.

While the above examples have been described in terms of downlink transmissions, those of skill in the art will appreciate that they can also apply to uplink communications. Moreover, it is understood that the claimed subject matter is not limited to any of these examples, as there may be other techniques that can be performed to appreciate power savings from the information provided by the power status messages.

While the various embodiments of the have been illustrated and described, it will be clear that the claimed subject matter is not so limited. Numerous modifications, changes, variations, substitutions and equivalents will occur to those skilled in the art without departing from the spirit and scope of the present invention as defined by the appended claims.

What is claimed is:

1. A priority scheme method for a communication system, comprising:
at a base station, receiving from one or more mobile devices a power status message;
allocating a data profile of a frame based on the power status messages to enable higher priority mobile devices to receive data in the frame before lower priority mobile devices.

2. The method according to claim 1, wherein allocating the data profile of a frame based on the power status messages includes scheduling in a downlink map or an uplink map data transmissions such that the data transmissions for the higher priority mobile devices are allocated before the data transmissions for the lower priority mobile devices.

3. The method according to claim 2, wherein the power status message indicates whether a mobile device is being powered by a portable power source or a non-portable power source.

4. The method according to claim 3, wherein if the power status message indicates that the mobile device is being powered by a portable power source, the power status message also indicates the amount of charge remaining on the portable power source.

5. The method according to claim 4, wherein a mobile device being powered by a portable power source is a higher priority mobile device and a mobile device being powered by a non-portable power source is a lower priority mobile device.

6. The method according to claim 5, wherein the data transmissions for a mobile device with a portable power source with a first amount of charge are scheduled before the data transmissions for a mobile device with a portable power source with a second amount of charge, wherein the first amount of charge is lower than the second amount of charge.

7. The method according to claim 1, further comprising allocating periods of absence based on the power status messages, wherein longer periods of absences are allocated to the higher priority mobile devices over the lower priority mobile devices.

8. The method according to claim 1, further comprising allocating larger data bursts based on the power status messages, wherein the larger data bursts are allocated to the higher priority mobile devices.

9. The method according to claim 1, further comprising dynamically cycling the allocation of data profiles based on the power status messages for subsequent frames.

10. The method according to claim 1, wherein the power status messages are discreet messages transmitted over an uplink channel or are part of a pre-existing message transmitted over the uplink channel.

11. A priority scheme method for a broadband communication system, comprising:
at a base station, receiving a power status message from one or more mobile devices, wherein the power status messages are associated with the type of power sources that are currently providing power to the mobile devices;
based on the power status messages, scheduling data transmissions for the mobile devices in a downlink map such that the transmissions intended for mobile devices providing power status messages that indicate a power critical status are allocated prior to the transmission intended for mobile devices providing power status messages that indicate a power non-critical status.

12. The method according to claim 11, further comprising, based on the power status messages, scheduling data transmissions for the mobile devices in an uplink map such that the transmissions from mobile devices providing power status messages that indicate a power critical status are allocated prior to the transmissions from mobile devices providing power status messages that indicate a power non-critical status.

13. The method according to claim 12, wherein the power critical status refers to the mobile device being currently powered by a battery and the power non-critical status refers to a mobile device being powered by a hard-wired power system.

14. A base station, comprising:
a transceiver that receives power status messages from one or more mobiles devices, wherein some of the mobile devices are powered by a portable power source and some of the mobile devices are powered by a non-portable power source;
a scheduler coupled to the transceiver, wherein the scheduler schedules data transmissions based on the power status messages, wherein the scheduler grants in a transmission map a higher priority to the data transmissions that are associated with the mobile devices powered by the portable power sources.

15. The base station according to claim 14, wherein the transmission map is a downlink map or an uplink map and the base station is part of a communication system that uses orthogonal frequency-division multiplexing (OFDM) modulation.

16. The base station according to claim 14, wherein the power status messages also indicate an amount of charge remaining on the portable power sources and the granting of priority by the scheduler is further based on the amount of charge remaining on the portable power sources.

17. The base station according to claim 14, wherein the scheduler further allocates periods of absence based on the power status messages, wherein longer periods of absences are allocated to the mobile devices with the portable power sources over the mobile devices with the non-portable power sources.

18. The base station according to claim 14, wherein the scheduler allocates larger data bursts based on the power status messages, wherein the larger data bursts are allocated to the mobile devices with the portable power sources over the mobile devices with the non-portable power sources.

19. The base station according to claim 14, wherein the scheduler dynamically cycles the allocation of data profiles based on the power status messages for subsequent frames.

20. The base station according to claim 14, wherein the receiver receives the power status messages as discreet messages transmitted over an uplink channel or as part of a pre-existing message transmitted over the uplink channel.
